(19) United States
(12) Patent Application Publication
(10) Pub. No.: US 2010/0004967 A1
(43) Pub. Date: Jan. 7, 2010

(54) Method and System for Generating One Flow Models from Runtime Service Delivery Process

(75) Inventors: Huang-Yang Chang, Scarsdale, NY (US); Santhosh Badu Kumaran, Peekskill, NY (US); Sreeram Ramakrishnan, Yorktown Heights, NY (US); Debanjan Saha, Mohegan Lake, NY (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 12/167,174

(22) Filed: Jul. 2, 2008

(51) Int. Cl. G06F 17/30

(52) U.S. Cl. 705/8; 707/3; 707/E17.014

(57) ABSTRACT

A method and system for generating new abstractions for existing process models and modifying existing process models in order to generate new process models by mining run-time service delivery processes. The method and system also “learns” new abstractions for business process models by modifying existing models. The method and system generates new business process models utilizing an online learning mechanism that mines run-time service delivery processes.

### I. FIELD OF THE INVENTION

This invention relates to a method and system for generating new abstractions for existing process models and modifying existing process models to generate new process models by mining run-time service delivery processes.

### II. BACKGROUND OF THE INVENTION

One of the critical challenges in the information technology (IT) services domain is the need to quickly and efficiently provision customized processes to handle service requests. These customized processes are often very complex, highly detailed, and uniquely tailored to address various aspects of the particular service request. These customized processes tend to comprise many independent solutions (atomic services) that are integrated to provide a comprehensive solution (composite service) for the service request. These atomic services and composite services are commonly stored as process templates in anticipation of being reused to fulfill subsequent service requests. However, existing process templates are very often unable to generate a process model for a particular service request due to the complexity and specificity of the process models and service requests.

While these existing process templates may fail to generate a desired or useful process model, they may nevertheless include process model components and other information that may be useful in identifying new process abstractions and generating a proper process model for the service request. Also, failed process templates, components, and other aspects of the existing process templates are useful in identifying and analyzing new process abstractions.

In order to preserve the opportunity of identifying new process abstractions from these instances where no single process model or process template exists, it is necessary to archive these instances such that they may be mined to identify new process abstractions.

### III. SUMMARY OF THE INVENTION

In at least one embodiment, the present invention provides a method, including receiving a business service request; determining whether at least one matching business process model required to fulfill the business service request exists; outputting the at least one matching business process model to a database of business process models when the matching business process models are found; provisioning a service plan for executing the service request when no matching business process models are found; outputting the service plan to the business process learning module; partitioning at least one service task associated with the generated service plan; and outputting the at least one service task to the business process learning module.

In at least another embodiment, the present invention provides a system including means for receiving a business service request; means for determining whether at least one matching business process model required to fulfill the business service request exists; means for outputting the at least one matching business process model to a database of business process models when matching business process models are found; means for provisioning a service plan for executing the service request when no matching business process models are found; means for outputting the service plan to the business process learning module; means for partitioning at least one service task associated with the generated service plan; and means for outputting the at least one service task to the business process learning module.

In at least another embodiment, the present invention provides a method including searching a database of business process models in order to determine whether business process models required to fulfill a business service request exist; creating a service plan for executing the business service request when no matching business process models are found in the database; outputting the service plan to a business process learning module; creating at least one service task for performing the business service request; outputting the at least one service task to the business process learning module; modifying the existing business process models when a matching business process model is found in the database in order to learn new business process models; and outputting the new business process models to the business process learning module.

In at least another embodiment, the present invention provides a computer program product including a computer useable medium that contains a computer readable program, wherein the computer readable program when executed on a computer causes the computer to receive a business service request; determine whether at least one matching business process model required to fulfill the business service request exists; output the at least one matching business process model to a database of business process models when matching business process models are found; provision a service plan for executing the service request when no matching business process models are found; output the service plan to the business process learning module; partition at least one service task associated with the generated service plan; and output the at least one service task to the business process learning module.

The present invention in at least one embodiment provides a method and system for learning new abstractions for existing one flow models (OFMs) by modifying the feature vectors used to define the business process models, or adding new business process models based on an online learning mechanism that mines run-time service delivery processes. The method and system utilizes a run-time service delivery process archiving and mining tool that incorporates an online learning mechanism.

### IV. BRIEF DESCRIPTION OF THE DRAWINGS

The present invention is described with reference to the accompanying drawings, wherein:

FIG. 1A illustrates an overview of the components according to an exemplary embodiment of the present invention.

FIG. 1B illustrates an overview of a method according to an exemplary embodiment of the present invention.

FIG. 2 illustrates phases of the method according to the exemplary embodiment of the present invention.

FIG. 3 illustrates the OFM comparison phase process according to an exemplary embodiment of the present invention.

FIG. 4 illustrates the service plan provisioning phase process according to an exemplary embodiment of the present invention.

FIG. 5 illustrates the OFM service plan instance log phase process according to an exemplary embodiment of the present invention.

FIG. 6 illustrates the OFM process mining phase according to an exemplary embodiment of the present invention.

FIG. 7 illustrates the OFM catalog update phase process according to an exemplary embodiment of the present invention.

Given the following enabling description of the drawings, the apparatus should become evident to a person of ordinary skill in the art.

### V. DETAILED DESCRIPTION OF THE DRAWINGS

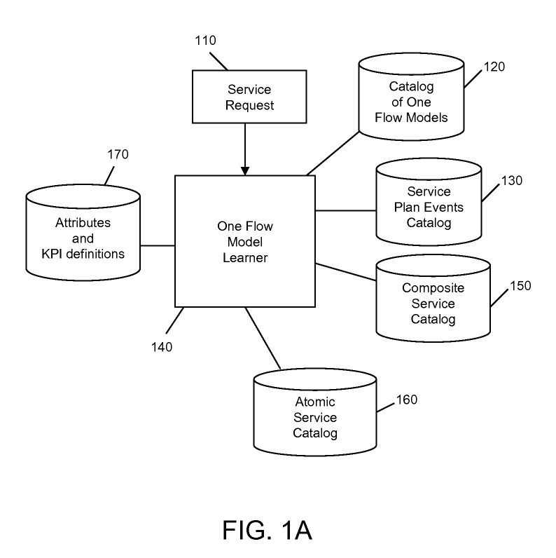

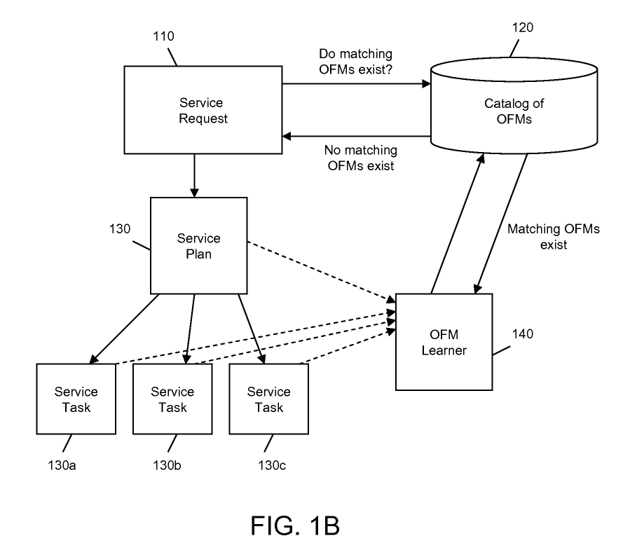

The present invention will be described in an information technology (IT) services environment and its advantages are best understood by referring to FIGS. 1-7. The present invention discloses a method and system that “learns” new abstractions for existing business process models, particularly, one flow models (OFMs), by modifying feature vectors used to define the OFMs. The present invention may also be utilized to generate new OFMs by utilizing an online learning mechanism that mines run-time business service delivery processes. The present invention is referred to and described herein with respect to the One Flow Model (OFM) representation of business processes. However, this disclosure is not intended to be limited to use with OFMs but can be used with other business process modeling techniques, particularly those that focus on process mining.

The present invention utilizes an OFM Learner Module to identify any matching OFMs, e.g., from a catalog. If no matching OFMs are identified in the catalog, the OFM Learner Module is triggered and the associated service delivery process is created semi-manually by a user and logged. Upon triggering, the OFM Learner Module continuously mines all such instances of processes that were created (semi-manually, without a reasonable match in the OFM catalog) in order to seek new OFM abstractions. The OFM Learner Module also investigates whether these processes could be assigned to any of the existing OFMs if the feature vectors used to define the existing OFMs could be modified without orphaning the service plan (delivery) instances already attached to that particular OFM. The new definitions may, for example, seek to accommodate a wider range of newly observed service plan instances thereby making the process more broadly useful.

The OFM Learner Module utilizes a mechanism based on modeling techniques, such as Hidden Markov Models (HMM), to determine hidden abstractions that may be further analyzed such that new OFM abstractions may be identified and/or generated. The OFM Learner Module also utilizes data analysis techniques, such as principal component analysis (PCA) or curvilinear component analysis, to reduce the data sets that define new feature vectors for the existing OFMs.

FIG. 1A illustrates an overview of exemplary components of the present invention. The various components of the system of the present invention communicate with a One Flow Model (OFM) Learner 140 and with each other. The system is triggered by receipt of a service request 110. The service request 110 prompts the system to search the OFM catalog 120 for OFMs matching those required to perform the requested service. If a match is found, that OFM is executed. If no match is found, a service plan 130, including associated service tasks, may be created semi-manually and executed. The service plan is created by utilizing composite and atomic services found in composite service catalog 150 and atomic services catalog 160, respectively. Once the execution is complete, the system searches the OFM catalog 120 for matching OFMs. If matches are found, the system attempts to discover or create (“learn”) new OFMs by modifying the existing OFMs. The modification includes adding attributes, definitions and indices in order to redefine the OFMs such that they become more functional, relevant and/or useful. These attributes, definitions and indices are stored to catalog 170.

FIG. 1B illustrates an overview of an example of a method of the present invention. The method begins at 110 by receiving a service request. After receiving the service request, catalog 120 is accessed to determine whether there are existing OFMs that match the service request. If no matching OFMs are found in catalog 120, a service request artifact or service plan 130 is semi-manually created for executing the service request. The service plan may be characterized by a pre-defined set of attributes that form the basis for developing the operational components of the service request, i.e., the service plan and service tasks. The set of attributes may include configurations, tools, platforms, skill level requirement, database types, etc. Service plan 130 includes one or more service tasks 130a, 130b, and 130c. Service plan 130 and service tasks 130a, 130b, and 130c are output to OFM Learner 140. OFM Learner 140 searches catalog 120 for OFMs that match the service plan and service tasks. If matching OFMs are found, those OFMs are modified with additional attributes, indices and descriptions. If matching OFMs are not found, the new OFMs (made up of service tasks 130a-130c) are added to the catalog 120. This method enables the generation of new abstractions for existing process models (OFMs) and the modification of existing process models to generate new process models by mining run-time service delivery processes.

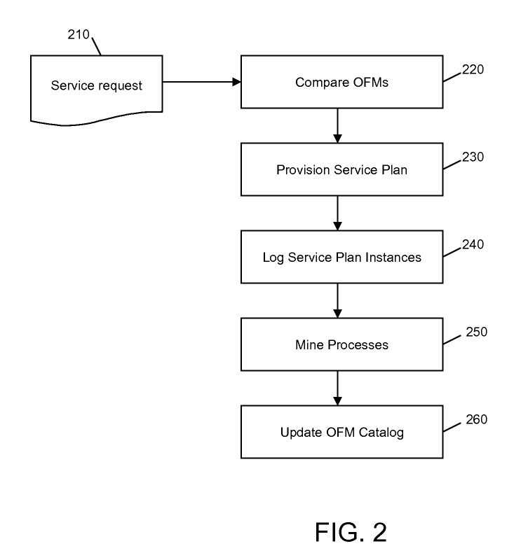

FIG. 2 illustrates exemplary phases of the method of the present invention. At 210, a service request is received. At 220, OFM comparison phase compares OFMs from service request 210 to OFMs stored in a catalog for possible matches. At 230, service plan provisioning phase allows for the semi-manual creation of a service plan and outputs the service plan. At 240, service plan instance log phase partitions atomic services (services tasks) associated with service plan and outputs the atomic services to a service plan events log. At 250, process mining phase performs a process mining operation by analyzing the current log of service plans and associated tasks by communicating with the service plan events log. At 260, OFM catalog update phase outputs and stores the newly identified OFMs into catalog 220.

The process mining phase at 250 performs two operations. These two operations are utilized in order to identify: (a) tasks that can be abstracted to new OFMs; or (b) tasks that can be mapped to existing OFMs if the attributes used to define the OFMs have changed, without “orphaning” (causing to be unauthorized, unaffiliated, or unsupported) any of the current “children” (individual) service plans. In the first process mining operation, an OFM Learner seeks to develop new OFMs from an existing log of service tasks. The set of attributes used for this operation is similar or identical to the set of attributes used to define the OFMs already in the catalog. The candidate OFMs (OFMs developed from this operation) are compared to existing OFMs and the best possible matches are identified based on pre-defined attributes and threshold levels. In the second mining operation, the OFM Learner investigates the possibility of altering existing OFMs by using different sets of attributes while not “orphaning” any of the past service plans associated with the potentially modified OFMs. In this operation, it is possible that some of the associated service plans may find new parent OFMs.

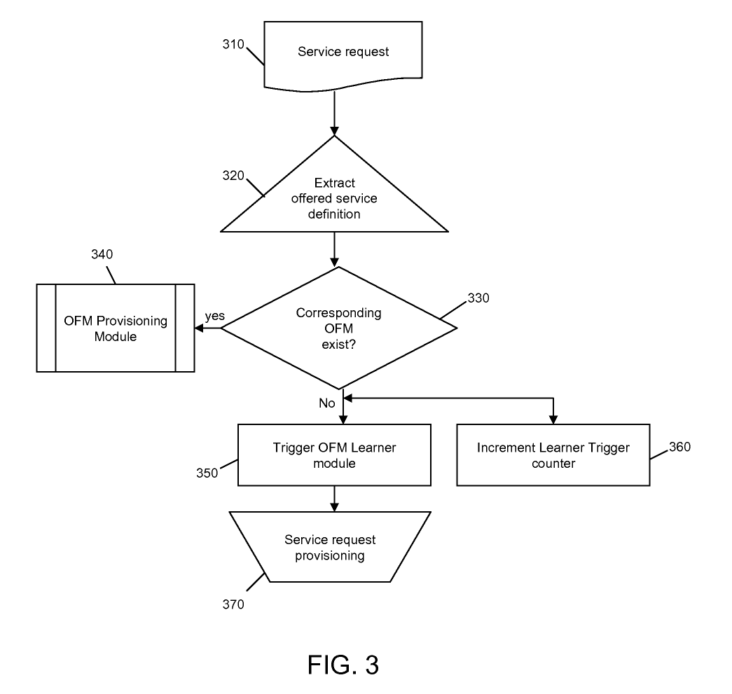

FIG. 3 illustrates an exempalary OFM comparison process of the present invention. At 310, a service request is received. At 320, associated definitions are extracted from the service request. At 330, a determination is made as to whether corresponding OFMs exist for the service request based on the associated definitions by accessing catalog 340. If Yes, the process proceeds to 350 and an OFM Provisioning Module provisions the requested service. If No, the process proceeds to 360 and activates OFM Learner Module which attempts to alter existing OFMs by using different sets of attributes while not orphaning any of the past service plans associated with the potentially modified OFM. At 370, a counter for OFM Learner Module is incremented to investigate different sets of attributes until a matching OFM is found. Once a matching OFM is found, the process proceeds to 380 and the OFM Provisioning Module provisions the requested service. This comparison of business models and provisioning of services may be a partially manual process allowing the utilization of specific domain knowledge.

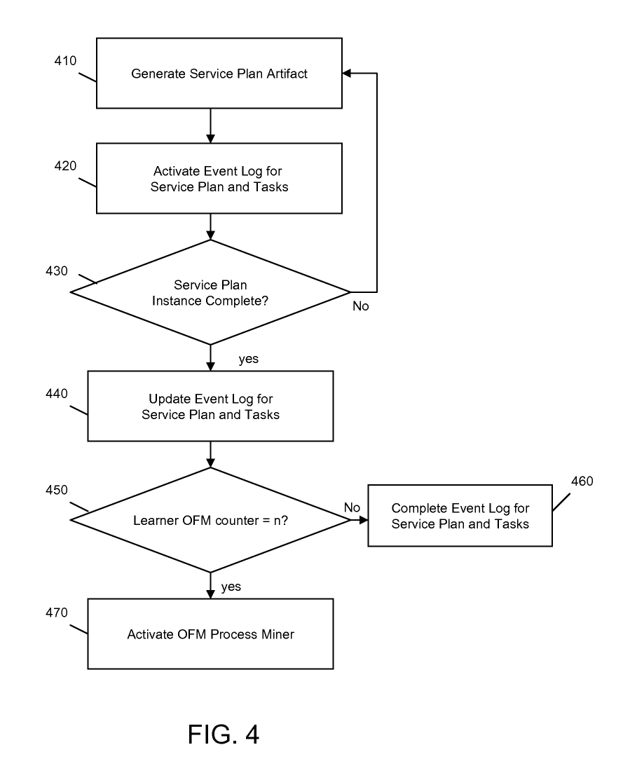

FIG. 4 illustrates the service plan provisioning phase process of the present invention. At 410, a service plan artifact is generated—either automatically or manually. At 420, an event log is activated for the service plan and service tasks. At 430, a determination is made as to whether the service plan instance is complete. If No, the process cycles back to 410 and is repeated. This process is repeated until all tasks required for the service plan are located and the service plan instance is complete. If Yes, the process proceeds to 440 and updates the event log for the service plan and service order tasks. The service plan and service order tasks are tracked to ensure that all tasks are performed. At 450, OFM Learner Trigger counter determines whether the number of steps performed equals “n” (the number of service order tasks or steps required by the service plan). If no, the process proceeds to 460 and completes an event log for the service plan and service tasks. If Yes, the process proceeds to 470 and triggers OFM Process Miner.

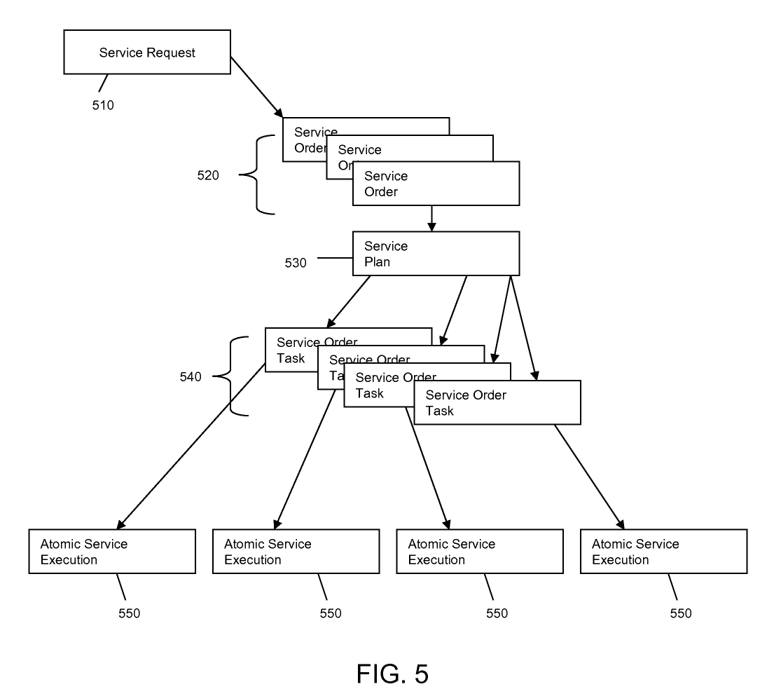

FIG. 5 illustrates an exemplary process of the service plan instance log phase of the present invention. At 510, a service order artifact is created upon receipt of a valid service request. At 520, service orders prompt the creation of a service plan by accessing a catalog of composite services 530. At 540, the service plan generates specific service order tasks 550 and their associated atomic services by accessing atomic service catalog 560. At 570, the atomic services are executed for the service order tasks.

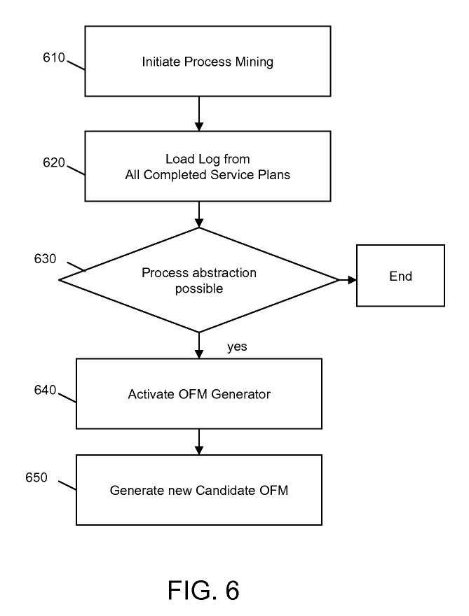

FIG. 6 illustrates an exemplary OFM process mining phase of the present invention. At 610, a process miner is initiated. The process miner accesses an OFM catalog in search of processes that match the service plan instances. A catalog of attributes and key performance indicators (KPIs) used to define the mined processes is accessed. Attributes and KPIs are retrieved from/added to the processes and updated in the catalog. At 240, logs of all completed service plans are accessed and loaded from an events log. At 630, a determination is made as to whether process abstraction is possible, i.e., whether new processes can be generated from the existing processes. If No, the process proceeds ends and stores the logs for possible use later. If Yes, the process proceeds to 640 and activates OFM Generator. At 650, new candidate OFMs are generated.

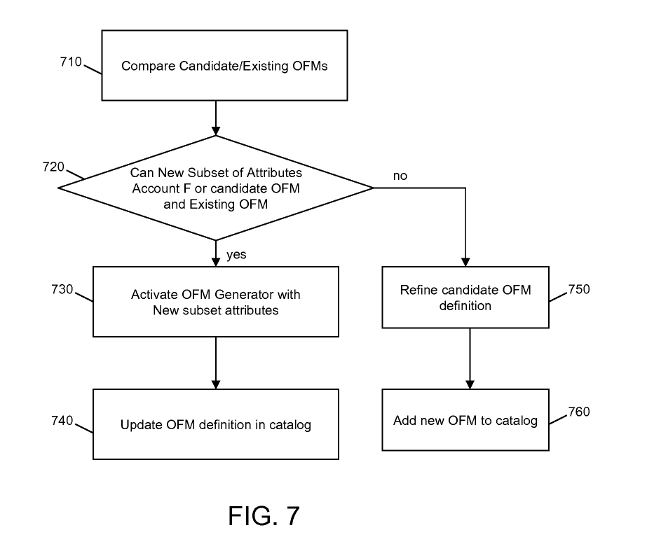

An exemplary OFM catalog update phase of the present invention is illustrated in FIG. 7. At 710, the existing OFMs are compared by accessing a catalog of OFMs. At 720, a determination is made as to whether new attributes can account for the candidate OFMs and the existing OFMs, i.e., the process attempts to refine the original definitions to make the process more simple. The process also seeks to avoid adding any new redundant OFMs as there can be significant cost associated with performing duplicate tasks. If Yes, the process proceeds to 730 and activates OFM Generator with a new subset of attributes. The system then proceeds to 740 and updates the OFM definition in the catalog. If No, the process proceeds to 750 and semi-manually refines the candidate OFM definition. At 760, the new OFM is added to the catalog. Once the new OFMs and updated OFM definitions are added to the catalog they made available for execution and may be utilized to generate abstractions for new OFMs.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As will be appreciated by one of ordinary skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, carrier signals/waves, or other storage devices.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A method, comprising:
receiving a business service request;
determining whether at least one matching business process model required to fulfill said business service request exists;
outputting said at least one matching business process model to a database of business process models when said matching business process models are found;
provisioning a service plan for executing said service request when no matching business process models are found;
outputting said service plan to said business process learning module;
partitioning at least one service task associated with said generated service plan; and
outputting said at least one service task to said business process learning module.

2. The method according to claim 1, wherein determining whether business process models required to fulfill said business service request exist, further comprises:
searching a database of business process models for business process models that match said business service request.

3. The method according to claim 1, further comprising:
modifying said matching business process models.

4. The method according to claim 3, wherein modifying said matching business process models includes adding attributes, indices, and descriptions.

5. The method according to claim 2, further comprising:
creating a new business process model from said at least one service task; and
outputting said new business process model to said database of business process models.

6. The method according to claim 2, further comprising:
mining said database of business process models for new business process abstractions; and
adding said new business process abstractions to said database of business process models.

7. The method according to claim 1, wherein said service request includes an offered service definition.

8. The method according to claim 7, wherein determining whether at least one business process model required to fulfill said business service request exist, comprises:
extracting said offered service definition from said service request; and
comparing said offered service definition to business process models stored in said database of business process models.

9. The method according to claim 7, further comprising:
triggering said business process learning module; and
incrementing a counter on said business process learning module.

10. A system, comprising:
means for receiving a business service request;
means for determining whether at least one matching business process model required to fulfill said business service request exists;
means for outputting said at least one matching business process model to a database of business process models when said matching business process models are found;
means for provisioning a service plan for executing said service request when no matching business process models are found;
means for outputting said service plan to said business process learning module;
means for partitioning at least one service task associated with said generated service plan; and
means for outputting said at least one service task to said business process learning module.

11. The system according to claim 10, wherein said means for determining whether business process models required to fulfill said business service request exist, further comprises:
means for searching a database of business process models for business process models that match said business service request.

12. The system according to claim 10, further comprising:
means for creating a new business process model from said at least one service task; and
means for outputting said new business process model to said database of business process models.

13. The system according to claim 10, further comprising:
means for mining said database of business process models for new business process abstractions; and
means for adding said new business process abstractions to said database of business process models.

14. The system according to claim 10, further comprising:
means for extracting an offered service definition from said service request; and
means for comparing said offered service definition to business process models stored in said database of business process models.

15. The system according to claim 10, further comprising:
means for triggering said business process learning module; and
means for incrementing a counter on said business process learning module.

16. A method, comprising:
searching a database of business process models to determine whether business process models required to fulfill a business service request exist;
creating a service plan for executing said business service request when no matching business process models are found in said database;
outputting said service plan to a business process learning module;
creating at least one service task for performing said business service request;
outputting said at least one service task to said business process learning module;
modifying said existing business process models when a matching business process models are found in said database in order to learn new business process models; and
outputting said new business process models to said business process learning module.

17. A computer program product comprising a computer useable medium including a computer readable program, wherein the computer readable program when executed on a computer causes the computer to:
receive a business service request;
determine whether at least one matching business process model required to fulfill said business service request exists;
output said at least one matching business process model to a database of business process models when matching business process models are found;
provision a service plan for executing said service request when no matching business process models are found;
output said service plan to said business process learning module;
partition at least one service task associated with said generated service plan; and
output said at least one service task to said business process learning module.

18. A computer program product according to claim 17, wherein the computer readable program further causes the computer to:
search a database of business process models for business process models that match said business service request.

19. A computer program product according to claim 17, wherein the computer readable program further causes the computer to:
modify said matching business process models.

20. A computer program product according to claim 19, wherein attributes, indices, and descriptions are used to modify said matching business process models.

21. A computer program product according to claim 18, wherein the computer readable program further causes the computer to:
create a new business process model from said at least one service task; and
output said new business process model to said database of business process models.

22. A computer program product according to claim 18, wherein the computer readable program further causes the computer to:
mine said database of business process models for new business process abstractions; and
add said new business process abstractions to said database of business process models.

23. A computer program product according to claim 18, wherein the computer readable program further causes the computer to:
extracting an offered service definition from said service request; and
comparing said offered service definition to business process models stored in said database of business process models.

24. A computer program product according to claim 18, wherein the computer readable program further causes the computer to:
triggering said business process learning module; and
incrementing a counter on said business process learning module.
